(19) United States
(12) Patent Application Publication
(10) Pub. No.: US 2025/0303851 A1
(43) Pub. Date: Oct. 2, 2025

(54) COOLING SYSTEM FOR IN-WHEEL MOTOR ASSEMBLY

(71) Applicant: TOYOTA JIDOSHA KABUSHIKI KAISHA, Toyota-shi (JP)

(72) Inventors: Masahiro MATSUZAWA, Susono-shi (JP); Taku IBUKI, Susono-shi (JP); Kazumasa SHIMODE, Susono-shi (JP)

(73) Assignee: TOYOTA JIDOSHA KABUSHIKI KAISHA, Toyota-shi (JP)

(21) Appl. No.: 19/079,772

(22) Filed: Mar. 14, 2025

(30) Foreign Application Priority Data
Mar. 27, 2024 (JP) 2024-052542

(51) Int. Cl. B60K 11/02; B60K 7/00; F16D 65/02; F16D 65/12; H02K 9/19

(52) U.S. Cl. CPC B60K 11/02; B60K 7/0007; F16D 65/128; H02K 9/19; B60K 2007/0061; F16D 2065/1328

(57) ABSTRACT

A cooling system for an in-wheel motor assembly that includes an electric motor and a brake device. The cooling system includes: a casing that houses the electric motor; a cooling device configured to cool a liquid medium; a first passage through which the liquid medium is to flow between an inside of the casing and a brake disc of the brake device; a second passage through which the liquid medium is to flow between the inside of the casing and the cooling device; first and second valves that are provided in the first and second passages, respectively; and a control apparatus configured to control opening/closing operations of each of the first and second valves based on a temperature of the electric motor and a temperature of the brake disc.

This application claims priority from Japanese Patent Application No. 2024-052542 filed on Mar. 27, 2024, the disclosure of which is herein incorporated by reference in its entirety.

### FIELD OF THE INVENTION

The present invention relates to a cooling system for an in-wheel motor assembly including an electric motor disposed in a space located on an inner peripheral side of a wheel.

### BACKGROUND OF THE INVENTION

There is well-known a cooling system for an in-wheel motor assembly that includes (i) a wheel onto which a tire is to be mounted, (ii) an electric motor which is connected to the wheel in a power transmittable manner and which includes a portion disposed in a space located on an inner peripheral side of the wheel, and (iii) a brake device which includes a brake disc disposed in the space and which is configured to apply a braking torque to the wheel. For example, Patent Document 1 discloses such an in-wheel motor assembly. This patent document 1 discloses an arrangement with two brake tubes, wherein a brake fluid is to be supplied to the brake device through one of the two brake tubes, and the brake fluid is to be discharged from the brake device and distributed through the other of the two brake tubes, and wherein the electric motor is to be cooled by the brake fluid when the brake fluid flows through at least one of the two brake tubes.

### PRIOR ART DOCUMENT

### Patent Document

### [Patent Document 1]

Japanese Patent Application Laid-Open No. 2009-113722

### SUMMARY OF THE INVENTION

By the way, in the above-described arrangement of the in-wheel motor assembly, the electric motor and the brake disc are close to each other in the space located on the inner peripheral side of the wheel. Thus, when the brake disc is heated to a high temperature due to heat generation during braking, heat of the brake disc is easily transmitted to the electric motor. Therefore, a cooling performance of the electric motor is likely to be reduced.

The present invention has been made in view of the above circumstances, and an object of the present invention is to provide a cooling system for an in-wheel motor assembly, wherein the cooling device is capable of improve a cooling performance of an electric motor that is included in the in-wheel motor assembly.

The present invention provides a cooling system for an in-wheel motor assembly that includes (i) a wheel onto which a tire is to be mounted, (ii) an electric motor which is connected to the wheel in a power transmittable manner and which includes a portion disposed in a space located on an inner peripheral side of the wheel, and (iii) a brake device which includes a brake disc disposed in the space and which is configured to apply a braking torque to the wheel. The cooling system includes: (a) a casing which houses the electric motor such that at least a part of the electric motor is immersed in a liquid medium that is stored in the casing; (b) a cooling passage which is defined in the brake disc so as to cool the liquid medium by heat exchange between the liquid medium and an outside air; (c) a cooling device which is configured to cool the liquid medium; (d) a first passage through which the liquid medium is to flow between an inside of the casing and the cooling passage; (e) a second passage through which the liquid medium is to flow between the inside of the casing and the cooling device; (f) a first valve which is provided in the first passage and which is to be selectively placed in an open state and a closed state, such that the first valve allows the liquid medium to flow through the first passage when being placed in the open state, and such that the first valve blocks the liquid medium from flowing through the first passage when being placed in the closed state; (g) a second valve which is provided in the second passage and which is to be selectively placed in an open state and a closed state, such that the second valve allows the liquid medium to flow through the second passage when being placed in the open state, and such that the second valve blocks the liquid medium from flowing through the second passage when being placed in the closed state; and (h) a control apparatus which is configured to control opening/closing operations of each of the first valve and the second valve based on a temperature of the electric motor and a temperature of the brake disc.

In the cooling system according to the present invention, there are provided the first passage through which the liquid medium is to flow between the inside of the casing (that houses the electric motor) and the cooling passage (that is defined in the brake disc) and the second passage through which the liquid medium is to flow between the inside of the casing and the cooling device. Further, there is provided the control apparatus configured to control the opening/closing operations of each of the first valve and the second valve based on the temperature of the electric motor and the temperature of the brake disc. Thus, the electric motor can be cooled by the cooling device through the liquid medium. Further, since the heat exchange is possible between the electric motor and the brake disc through the liquid medium, cooling and warming up utilizing a temperature difference therebetween are possible. Further, since the flow of the liquid medium in each of the first passage and the second passage is allowed or blocked depending on the temperature of the electric motor and the temperature of the brake disc, the electric motor is appropriately cooled or warmed up. Therefore, the cooling performance of the electric motor can be improved. Maintaining the temperature of the electric motor in an optimum range leads to improvement in an operation efficiency of the electric motor.

Further, in the cooling system according to the present invention, it is possible to obtain an auxiliary effect that the brake disc is appropriately cooled or warmed up. Therefore, the cooling performance of the brake disc can be improved, too. The temperature of the brake disc being maintained in an optimum range leads to appropriate maintenance of a braking action of the brake device.

The present invention is a technique that leads to suppression of temperature rise, improvement of cooling efficiency and thermal management of each of the electric motor and the brake disc.

### BRIEF DESCRIPTION OF THE DRAWINGS

FIG. 1 is a view schematically showing a vehicle that includes an in-wheel motor assembly and a cooling system that is constructed according to an embodiment of the present invention;

FIG. 2 is a cross-sectional view schematically showing constructions of the in-wheel motor assembly and the cooling system;

FIG. 3 is a view for explaining the construction of the cooling system for the in-wheel motor assembly;

FIG. 4 is a table showing, by way of examples, opening/closing operations of each of a first valve and a second valve based on an MG temperature and a disc temperature; and

FIG. 5 is a flowchart for explaining a main part of a control operation performed by an electronic control apparatus, for improving a cooling performance of an electric motor that is included in the in-wheel motor assembly.

### DETAILED DESCRIPTION OF PREFERRED EMBODIMENT

Hereinafter, an embodiment of the present invention will be described in detail with reference to the drawings.

### Embodiment

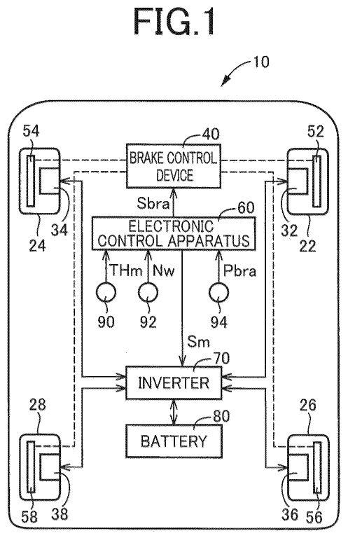

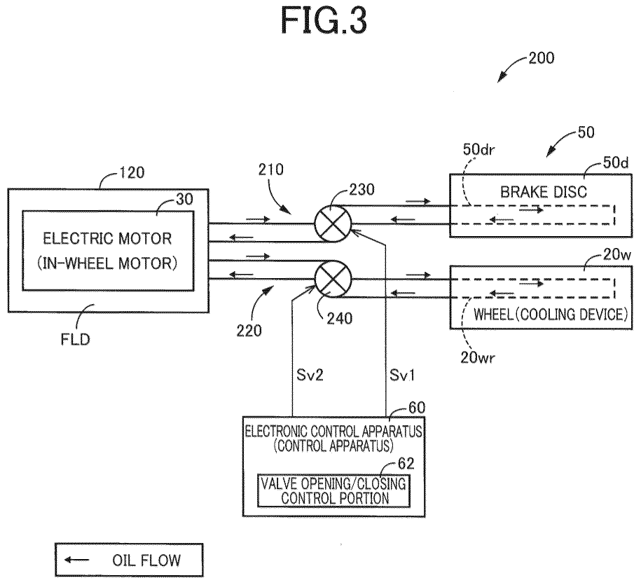

FIG. 1 is a view schematically showing a vehicle 10 that includes an in-wheel motor assembly and a cooling system 200 (see FIG. 3) that is constructed according to an embodiment of the present invention. As shown in FIG. 1, the vehicle 10 includes four drive wheels 20, four electric motors (four in-wheel motors) 30 provided for the respective drive wheels 20, a brake control device 40, four brake devices 50 provided for the respective drive wheels 20, and an electronic control apparatus 60. The four drive wheels 20 include a front right wheel 22, a front left wheel 24, a rear right wheel 26 and a rear left wheel 28. The four electric motors 30 include a front right motor 32, a front left motor 34, a rear right motor 36 and a rear left motor 38. The four brake devices 50 include a front right brake 52, a front left brake 54, a rear right brake 56 and a rear left brake 58. The vehicle 10 is a four wheel drive vehicle (=all-wheel drive vehicle) capable of adjusting torque distribution to the four drive wheels 20. The “right and left” are right and left with respect to a forward direction of the vehicle 10.

Each of the four electric motors 30 is a power source that generates a power serving as a driving torque. Each electric motor 30 is a known rotary electric machine, and is a so-called motor generator. The electric motors 30 are connected to a battery 80 provided in the vehicle 10 via an inverter 70 provided in the vehicle 10. The inverter 70 is controlled by the electronic control apparatus 60, whereby the MG torque Tm, which is an output torque of each electric motor 30, is controlled. The power is synonymous with a torque or force unless otherwise distinguished.

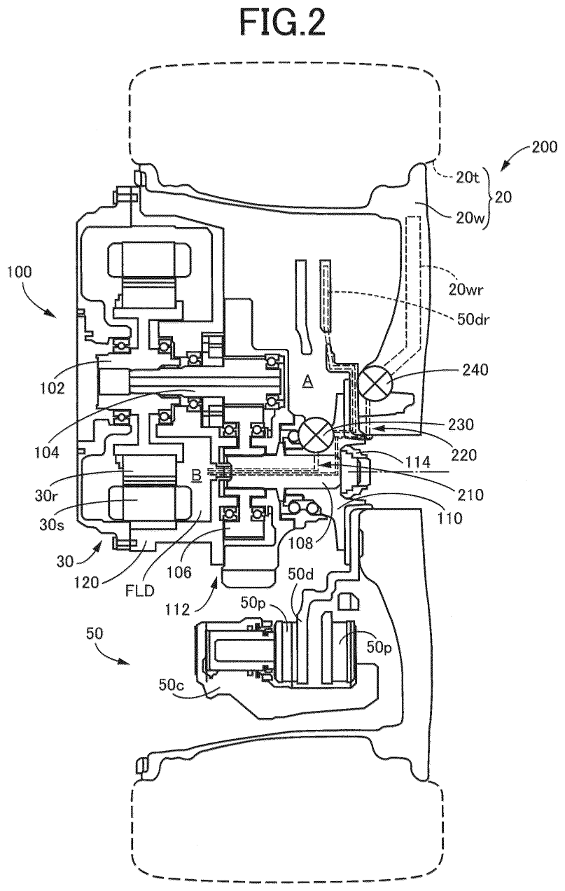

The brake control device 40 includes a brake master cylinder (not shown) and brake actuators (not shown) each of which generates a brake hydraulic pressure Pbra. The brake control device 40 controls a braking torque Tbra applied to each of the drive wheels 20 by a corresponding one of the brake devices 50 in accordance with a command supplied from the electronic control apparatus 60. The brake control device 40 causes the brake hydraulic pressure Pbra to be supplied to a cylinder of a caliper 50c (see FIG. 2) of each of the brake devices 50. When the brake hydraulic pressure Pbra is supplied to the cylinder of the caliper 50c, pads 50p (see FIG. 2) of a corresponding one of the brake devices 50 are pressed against a brake disc 50d (see FIG. 2) of the corresponding the brake device 50, and the braking torque Tbra is applied by a friction force. In the brake control device 40, in a normal state, a master cylinder hydraulic pressure, which is generated from the brake master cylinder and has a magnitude corresponding to a brake operation amount by a driver of the vehicle 10, is supplied to the cylinder of the caliper 50c as the brake hydraulic pressure Pbra. On the other hand, in the brake control device 40, for example, when an automatic brake control is operated, the brake hydraulic pressure Pbra having a magnitude corresponding to the braking torque Tbra required for each control is supplied to the cylinder of the caliper 50c. The brake disc 50d is also referred to as a brake rotor or a disc rotor.

The electronic control apparatus 60 is a controller including a control apparatus of the vehicle 10. The electronic control apparatus 60 includes a so-called microcomputer including, for example, a CPU, a RAM, a ROM and an input/output interface. The CPU executes various controls of the vehicle 10 by performing signal processing in accordance with programs stored in the ROM in advance while using a temporary storage function of the RAM.

Various signals and the like based on detection values from various sensors and the like provided in the vehicle 10 are supplied to the electronic control apparatus 60. The various sensors and the like are, for example, an MG temperature sensor 90, a wheel speed sensor 92, a brake hydraulic-pressure sensor 94 and the like. The various signals include, for example, an MG temperature THm, a wheel speed Nw, the brake hydraulic pressure Pbra and the like. The MG temperature sensor 90 includes a temperature sensor provided in each of the four electric motors 30. The wheel speed sensor 92 includes a wheel speed sensor provided for each of the four drive wheels 20. The brake hydraulic-pressure sensor 94 includes a hydraulic pressure sensor provided in each of the four brake devices 50. The MG temperature THm includes the temperature of each of the four electric motors 30. The wheel speed Nw includes the rotational speed of each of the four drive wheels 20. The brake hydraulic pressure Pbra includes the brake hydraulic pressure Pbra of each of the four brake devices 50.

The electronic control apparatus 60 outputs various command signals to various devices provided in the vehicle 10. The various devices are, for example, the brake control device 40 and the inverter 70. The various command signals are, for example, a brake control command signal Sbra, an MG control command signal Sm, and the like. The brake control command signal Sbra is a command signal for controlling the braking torque Tbra applied to each of the four drive wheels 20. The MG control command signal Sm is a torque command value for controlling the MG torque Tm of each of the four electric motors 30.

FIG. 2 is a cross-sectional view schematically showing a construction of a power transmission device 100 of the in-wheel motor assembly. The vehicle 10 includes the power transmission device 100 provided for each of the four drive wheels 20 and each of the four electric motors 30. The power transmission device 100 transmits the power of a corresponding one of the four electric motors 30 to a corresponding one of the four drive wheels 20.

As shown in FIG. 2, the drive wheel 20 includes a tire 20t and a wheel 20w on which the tire 20t is mounted. The power transmission device 100 is disposed in a space A located on the inner peripheral side of the wheel 20w. The power transmission device 100 includes a rotor shaft 102, an intermediate shaft 104, a gear 106, an output shaft 108 and a wheel hub 110. The cooling system 200 includes a casing 120 which is a non-rotating member and which houses the electric motor 30, the rotor shaft 102, the intermediate shaft 104, the gear 106 and the like. A stator 30s of the electric motor 30 is fixed to the casing 120.

The rotor shaft 102 is a rotary member that is to be rotated integrally with the rotor 30r of the electric motor 30. The intermediate shaft 104 is disposed coaxially with the rotor shaft 102, and an outer circumferential surface of the intermediate shaft 104 is, for example, spline-fitted to an inner circumferential surface of the rotor shaft 102.

The gear 106 is disposed coaxially with the output shaft 108, and is integrally connected to an outer circumferential surface of the output shaft 108 by, for example, press fitting. Gear teeth formed on an outer circumferential surface of the gear 106 are meshed with gear teeth formed on an outer circumferential surface of the intermediate shaft 104, which is located on a side opposite to the rotor shaft 102. At this meshing portion, the gear 106 has a larger diameter than the intermediate shaft 104. Thus, the gear teeth formed on the outer circumferential surface of the intermediate shaft 104 located on the side opposite to the rotor shaft 102, the gear 106 and the output shaft 108 constitute a parallel-shaft-type speed reducer 112.

The wheel hub 110 is disposed coaxially with the output shaft 108, and transmits a rotational output from the parallel-shaft-type speed reducer 112 to the drive wheel 20. The wheel hub 110 is press-fitted on the output shaft 108 on a side opposite to the parallel-shaft-type speed reducer 112, for example, and is fastened by a nut 114 fixed on the output shaft 108. The wheel 20w and the brake disc 50d are fixed to the wheel hub 110 by bolts (not shown). The brake disc 50d is disposed in the space A located on the inner peripheral side of the wheel 20w.

In the power transmission device 100, the power of the electric motor 30 is transmitted to the drive wheel 20 sequentially through the rotor shaft 102, the intermediate shaft 104, the gear 106, the output shaft 108 and the wheel hub 110.

The electric motor 30, which functions as an in-wheel motor, is connected to the wheel 20w in a power transmittable manner, and includes a portion disposed in the space A located on the inner peripheral side of the wheel 20w.

The brake device 50 includes the above-described caliper 50c, brake disc 50d and pads 50p, and applies the braking torque Tbra to the wheel 20w.

In the in-wheel motor assembly, the brake disc 50d and the electric motor 30 are close to each other. Therefore, heat generated in the brake disc 50d during braking is transmitted to the electric motor 30, and the MG temperature THm is made to easily rise.

The casing 120 in which the electric motor 30 is housed is fluid-tight, and an oil FLD as a liquid medium for lubricating the electric motor 30 is stored in an internal space B of the casing 120. In the casing 120, a at least a part of the electric motor 30 is immersed in the oil FLD that is stored in the internal space B of the casing 120. In the present embodiment, the cooling performance of the electric motor 30 is improved by using the oil FLD.

FIG. 3 is a view for explaining the construction of the cooling system 200 for the in-wheel motor assembly. The cooling system 200 is provided for each of the four drive wheels 20 and each of the four electric motors 30. Referring also to FIG. 2, the cooling system 200 will now be described.

As shown in FIG. 3, the cooling system 200 includes the above-described casing 120, a first cooling passage 50dr, a first passage 210, a second passage 220, a first valve 230, a second valve 240 and the above-described electronic control apparatus 60.

The wheel 20w has a second cooling passage 20wr provided therein, for cooling the oil FLD by heat exchange between the oil FLD and an outside air. In the cooling system 200, the wheel 20w defining therein the second cooling passage 20wr functions as a cooling device configured to cool the oil FLD.

The first cooling passage 50dr is defined inside the brake disc 50d. The first cooling passage 50dr is provided to cool the oil FLD by heat exchange between the oil FLD and the outside air.

The first passage 210 is provided to allow the oil FLD to flow between an inside of the casing 120 and the brake disc 50d (particularly, the first cooling passage 50dr). The second passage 220 is provided to circulate the oil FLD between the inside of the casing 120 and the wheel 20w (particularly, the second cooling passage 20wr). The inside of the casing 120 is synonymous with the internal space B of the casing 120. Each of the first passage 210 and the second passage 220 is provided inside the output shaft 108 and inside the wheel hub 110.

The first valve 230 is provided in the first passage 210. The first valve 230 is an electromagnetic valve that is selectively placed in an open state and a closed state such that the first valve 230 allows the oil FLD to flow through the first passage 210 when being placed in the open state, and such that the first valve 230 blocks the oil FLD from flowing through the first passage 210 when being placed in the closed state. The second valve 240 is provided in the second passage 220. The second valve 240 is an electromagnetic valve that is selectively placed in an open state and a closed state such that the second valve 240 allows the oil FLD to flow through the second passage 220 when being placed in the open state, and such that the second valve 240 blocks the oil FLD from flowing through the second passage 220 when being placed in the closed state.

The electronic control apparatus 60 functionally includes a valve opening/closing control portion 62 that controls opening/closing operations of each of the first valve 230 and the second valve 240 based on the MG temperature THm and the disc temperature THd. The disc temperature THd is a temperature of the brake disc 50d. The electronic control apparatus 60 outputs a first opening/closing control command signal Sv1 to the first valve 230 and outputs a second opening/closing control command signal Sv2 to the second valve 240.

The valve opening/closing control portion 62 obtains the MG temperature THm and the disc temperature THd. The valve opening/closing control portion 62 obtains the MG temperature THm based on, for example, a signal from the MG temperature sensor 90. The valve opening/closing control portion 62 obtains the disc temperature THd by calculating an estimated value of the disc temperature THd, for example. The valve opening/closing control portion 62 calculates an estimated value of the disc temperature THd by applying the wheel speed Nw, the brake hydraulic pressure Pbra, an operation time of the brake device 50 and the like to a map or a relational expression that is obtained and stored in advance experimentally or in design, that is, determined in advance.

The valve opening/closing control portion 62 makes determinations as to whether each of the electric motor 30 and the brake disc 50d is in a high temperature state that requires cooling, a low temperature state that requires warming-up or an optimum temperature state that is between the high temperature state and the low temperature state, namely, which one of the high temperature state, the low temperature state and the optimum temperature state each of the electric motor 30 and the brake disc 50d is in.

The valve opening/closing control portion 62 controls the opening/closing operations of each of the first valve 230 and the second valve 240 based on results of the above-described determination as to whether each of the electric motor 30 and the brake disc 50d is in the high temperature state, the low temperature state or the optimum temperature state. The valve opening/closing control portion 62 outputs a first opening/closing control command signal Sv1 to control the opening/closing operations of the first valve 230. The valve opening/closing control portion 62 outputs a second opening/closing control command signal Sv2 to control the opening/closing operations of the second valve 240.

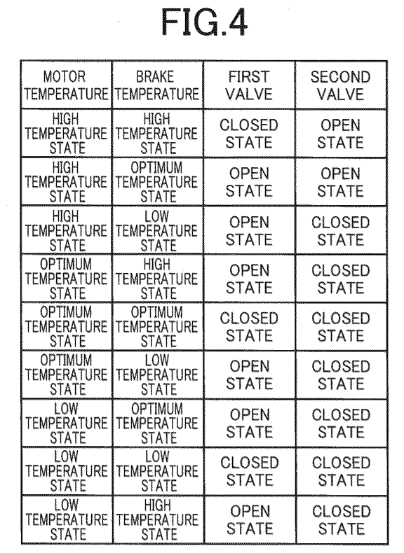

FIG. 4 is a table showing, by way of examples, the opening/closing operations of each of the first valve 230 and the second valve 240 based on the MG temperature THm and the disc temperature THd. In FIG. 4, “MOTOR TEMPERATURE” is synonymous with the MG temperature THm, and “BRAKE TEMPERATURE” is synonymous with the disc temperature THd.

In FIG. 4, when each of the MG temperature THm and the disc temperature THd is in a high temperature range, namely, each of the electric motor 30 and the brake disc 50d is in the high temperature state, it is considered problematic that the electric motor 30 is at a high temperature, and heat of the brake disc 50d is transmitted to the electric motor 30 through the oil FLD. In this case, first, priority is given to cooling the electric motor 30. When the valve opening/closing control portion 62 determines that each of the electric motor and the brake disc 50d is in the high temperature state, the valve opening/closing control portion 62 places the first valve 230 in the closed state and places the second valve 240 in the open state. Thus, heat of the brake disc 50d can be prevented from being transmitted to the electric motor 30 through the oil FLD, and the electric motor 30 can be cooled by the wheel 20w.

When the electric motor 30 is in the high temperature state and the brake disc 50d is in the optimum temperature state, it is considered problematic that the electric motor is at a high temperature. In this case, the electric motor 30 is made at an optimum temperature by the circulation of the oil FLD in the first passage 210 and the second passage 220. When the valve opening/closing control portion 62 determines that the electric motor is in the high temperature state and that the brake disc 50d is in the optimum temperature state, the valve opening/closing control portion 62 places each of the first and second valves 230, 240 in the open state. Thus, heat of the electric motor 30 can be dissipated both in the brake disc 50d and in the wheel 20w.

When the electric motor 30 is in the high temperature state and the brake disc 50d is in the low temperature state, it is considered problematic that the electric motor 30 is at a high temperature and the brake disc 50d is at a low temperature. In this case, each of the electric motor 30 and the brake disc 50d is made at an optimum temperature by the circulation of the oil FLD in the first passage 210. At this time, if the second valve 240 is placed in the open state, heat of the electric motor 30 could be released in the wheel 20w. However, the flow rate of the oil FLD in the first passage 210 is reduced, so that it would take time to make the brake disc 50d at the optimum temperature. Therefore, the second valve 240 is placed in the closed state so as to increase the flow rate of the oil FLD in the first passage 210, thereby accelerating heat exchange between the electric motor 30 and the brake disc 50d. When the valve opening/closing control portion 62 determines that the electric motor 30 is in the high temperature state and that the brake disc 50d is in the low temperature state, the valve opening/closing control portion 62 places the first valve 230 in the open state and places the second valve 240 in the closed state. Thus, heat of the electric motor 30 can be released in the brake disc 50d.

When the electric motor 30 is in the optimum temperature state and the brake disc 50d is in the high temperature state, it is considered problematic that the brake disc 50d is at a high temperature. In this case, the brake disc 50d is made at an optimum temperature by the circulation of the oil FLD in the first passage 210. At this time, the second valve 240 is placed in the closed state so as to increase the flow rate of the oil FLD in the first passage 210, thereby accelerating heat exchange between the electric motor 30 and the brake disc 50d. When the valve opening/closing control portion 62 determines that the electric motor is in the optimum temperature state and that the brake disc 50d is in the high temperature state, the valve opening/closing control portion 62 places the first valve 230 in the open state and places the second valve 240 in the closed state. Thus, the brake disc 50d can be cooled quickly.

When each of the electric motor 30 and the brake disc 50d is in the optimum temperature state, if the first valve 230 and/or the second valve 240 are/is opened, the electric motor 30 is likely to be poorly lubricated. In this case, the lubrication of the electric motor is prioritized. When the valve opening/closing control portion 62 determines that each of the electric motor 30 and the brake disc 50d is in the optimum temperature state, the valve opening/closing control portion 62 closes both the first valve 230 and the second valve 240. Thus, the electric motor 30 can be quickly lubricated and kept warm.

When the electric motor 30 is in the optimum temperature state and the brake disc 50d is in the low temperature state, it is considered problematic that the brake disc 50d is at a low temperature. In this case, the brake disc 50d is made at an optimum temperature by the circulation of the oil FLD in the first passage 210. At this time, cooling by the wheel 20w is not performed. When the valve opening/closing control portion 62 determines that the electric motor 30 is in the optimum temperature state and that the brake disc 50d is in the low temperature state, the valve opening/closing control portion 62 places the first valve 230 in the open state and places the second valve 240 in the closed state. Thus, heat dissipation from the wheel 20w can be blocked, and the brake disc 50d can be warmed up by the electric motor 30.

When the electric motor 30 is in the low temperature state and the brake disc 50d is in the optimum temperature state, it is considered problematic that the electric motor is at a low temperature. In this case, the electric motor 30 is made at an optimum temperature by the circulation of the oil FLD in the first passage 210. At this time, the second valve 240 is placed in the closed state so as to increase the flow rate of the oil FLD in the first passage 210, thereby accelerating heat exchange between the electric motor 30 and the brake disc 50d. When the valve opening/closing control portion 62 determines that the electric motor 30 is in the low temperature state and the brake disc 50d is in the optimum temperature state, the valve opening/closing control portion 62 places the first valve 230 in the open state and places the second valve 240 in the closed state. Thus, heat dissipation from the wheel 20w can be blocked, and the electric motor 30 can be quickly warmed up.

When each of the electric motor 30 and the brake disc 50d is in the low temperature state, it is considered problematic that both the electric motor 30 and the brake disc 50d are at low temperatures. In this case, cooling by the circulation of the oil FLD in the first passage 210 and the second passage 220 is not performed. When the valve opening/closing control portion 62 determines that each of the electric motor 30 and the brake disc 50d is in the low temperature state, the valve opening/closing control portion 62 closes both the first valve 230 and the second valve 240. Thus, heat dissipation in the wheel 20w and the brake disc 50d can be blocked, and the electric motor 30 can be quickly lubricated and warmed up.

When the electric motor 30 is in the low temperature state and the brake disc 50d is in the high temperature state, it is considered problematic that the electric motor 30 is in the low temperature state and that the brake disc 50d is in the high temperature state. In this case, the electric motor 30 and the brake disc 50d are made at optimum temperatures by the circulation of the oil FLD in the first passage 210. At this time, the second valve 240 is placed in the closed state so as to increase the flow rate of the oil FLD in the first passage 210, thereby accelerating heat exchange between the electric motor 30 and the brake disc 50d. Further, cooling by the wheel 20w is not performed. When the valve opening/closing control portion 62 determines that the electric motor 30 is in the low temperature state and the brake disc 50d is in the high temperature state, the valve opening/closing control portion 62 places the first valve 230 in the open state and places the second valve 240 in the closed state. Thus, the heat generated in the brake disc 50d is transmitted to the electric motor 30, and the electric motor 30 can be quickly warmed up.

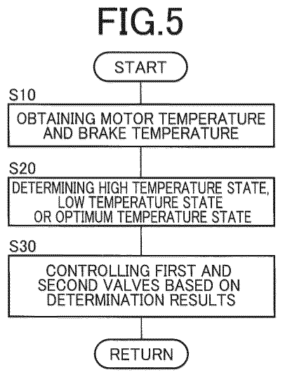

FIG. 5 is a flowchart for explaining a main part of the control operation performed by the electronic control apparatus 60, namely, a control routine executed by the electronic control apparatus 60, for improving the cooling performance of the electric motor 30. This control routine is executed in a repeated manner, for example.

In FIG. 5, each step of the control routine corresponds to function of the valve opening/closing control portion 62. First, at step S10, the MG temperature THm and the disc temperature THd are obtained. Next, step S20 is implemented to make determinations as to whether each of the electric motor 30 and the brake disc 50d is in the high temperature state, the low temperature state or the optimum temperature state.

Next, at S30, the opening/closing operations of each of the first and second valves 230, 240 are are controlled based on results of the above-described determinations made at step S20.

As described above, in the cooling system 200 according to the present embodiment, there are provided the first passage 210 through which the oil FLD is to flow between the inside of the casing 120 (that houses the electric motor 30) and the first cooling passage 50dr (that is defined in the brake disc 50d) and the second passage 220 through which the oil FLD is to flow between the inside of the casing 120 and the wheel 20w as the cooling device. Further, there is provided the electronic control apparatus 60 configured to control the opening/closing operations of each of the first valve 230 and the second valve 240 that are provided in the first passage 210 and the second passage 220, respectively, based on the MG temperature THm and the disc temperature THd. Thus, the electric motor 30 can be cooled by the wheel 20w through the oil FLD. Further, since the heat exchange is possible between the electric motor 30 and the brake disc 50d through the oil FLD, cooling and warming up utilizing a temperature difference therebetween are possible. Further, since the flow of the oil FLD in each of the first passage 210 and the second passage 220 is allowed or blocked depending on the MG temperature THm and the disc temperature THd, the electric motor 30 is appropriately cooled or warmed up. Therefore, the cooling performance of the electric motor 30 can be improved. Maintaining the MG temperature THm in an optimum range leads to improvement in an operation efficiency of the electric motor 30.

In the cooling system 200 according to the present embodiment, it is possible to obtain an auxiliary effect that the brake disc 50d is appropriately cooled or warmed up. Therefore, the cooling performance of the brake disc 50d can be improved, too. The temperature of the brake disc 50d being maintained in an optimum range leads to appropriate maintenance of a braking action of the brake device 50.

In the cooling system 200 according to the present embodiment, the MG temperature THm and the disc temperature THd are obtained, it is determined whether each of the electric motor 30 and the brake disc 50d is in the high temperature state, the low temperature state or the optimum temperature state, namely, it is determined which one of the high temperature state, the low temperature state and the optimum temperature state each of the electric motor 30 and the brake disc 50d is in. Then, the opening/closing operations of each of the first valve 230 and the second valve 240 are controlled depending on the determination results. Thus, the electric motor 30 is appropriately cooled or warmed up, and thus the operation efficiency of the electric motor 30 is appropriately improved.

In the cooling system 200 according to the present embodiment, when it is determined that both the MG temperature THm and the disc temperature THd are in the high temperature states, the first valve 230 is placed in the closed state while the second valve 240 is placed in the open state. When it is determined that both the MG temperature THm and the disc temperature THd are in the low temperature states, both the first valve 230 and the second valve 240 are placed in the closed states. Thus, the electric motor 30 can be maintained at an optimum temperature, and the operation efficiency of the electric motor 30 can be appropriately improved.

In the cooling system 200 according to the present embodiment, the wheel 20w in which the second cooling passage 20wr for cooling the oil FLD is formed functions as the cooling device for cooling the oil FLD. Thus, it is not necessary to provide a cooling device dedicated for cooling the oil FLD.

Although the embodiment of the present invention has been described in detail with reference to the drawings, the present invention is also applicable to other embodiments.

For example, in the above-described embodiment, the oil FLD is exemplified as the liquid medium for performing the heat exchange, but the invention is not limited to this example. For example, cooling water or the like may be used as the liquid medium. That is, the present invention can be applied not only to the cooling system by oil cooling but also to the cooling system by water cooling.

In the above-described embodiment, the wheel 20w is exemplified as the cooling device for cooling the liquid medium. For example, the cooling device may be a cooler dedicated for cooling the liquid medium.

In the above-described embodiment, an all-wheel drive vehicle including the drive wheels 20 of which all the wheels are to be driven by in-wheel motors is exemplified as the vehicle including the in-wheel motor assembly. However, the invention is not limited to this example. For example, the vehicle may be a vehicle in which only the front wheels or only the rear wheels are drive wheels that are to be driven by in-wheel motors. In this case, other wheels other than the drive wheels driven by the in-wheel motors may be driven wheels or may be drive wheels to which a power distributed by a differential gear device is to be transmitted.

In the above-described embodiment, the MG temperature THm is obtained based on the signal from the MG temperature sensor 90, and the estimated value of the disc temperature THd is calculated based on the wheel speed Nw and the like so as to obtain the disc temperature THd. However, the present invention is not limited to this example. For example, the MG temperature THm may be estimated and obtained based on an operation load of the electric motor 30 or the like, or based on the temperature of the oil FLD in the casing 120 or the like. Alternatively, the disc temperature THd may be obtained based on a signal from a temperature sensor.

The above description is merely one embodiment, and the present invention can be carried out in a mode in which various modifications and improvements are added based on the knowledge of those skilled in the art.

### NOMENCLATURE OF ELEMENTS

20t: tire
20w: wheel (cooling device)
20wr: second cooling passage
30: electric motor
50: brake device
50d: brake disc
50dr: first cooling passage
60: electronic control apparatus (control apparatus)
120: casing
200: cooling system
210: first passage
220: second passage
230: first valve
240: second valve
A: space located on inner peripheral side of wheel
FLD: oil (liquid medium)

What is claimed is:

1. A cooling system for an in-wheel motor assembly that includes (i) a wheel onto which a tire is to be mounted, (ii) an electric motor which is connected to the wheel in a power transmittable manner and which includes a portion disposed in a space located on an inner peripheral side of the wheel, and (iii) a brake device which includes a brake disc disposed in the space and which is configured to apply a braking torque to the wheel,
the cooling system comprising:
a casing which houses the electric motor such that at least a part of the electric motor is immersed in a liquid medium that is stored in the casing;
a cooling passage which is defined in the brake disc so as to cool the liquid medium by heat exchange between the liquid medium and an outside air;
a cooling device which is configured to cool the liquid medium;
a first passage through which the liquid medium is to flow between an inside of the casing and the cooling passage;
a second passage through which the liquid medium is to flow between the inside of the casing and the cooling device;
a first valve which is provided in the first passage and which is to be selectively placed in an open state and a closed state, such that the first valve allows the liquid medium to flow through the first passage when being placed in the open state, and such that the first valve blocks the liquid medium from flowing through the first passage when being placed in the closed state;
a second valve which is provided in the second passage and which is to be selectively placed in an open state and a closed state, such that the second valve allows the liquid medium to flow through the second passage when being placed in the open state, and such that the second valve blocks the liquid medium from flowing through the second passage when being placed in the closed state; and
a control apparatus which is configured to control opening/closing operations of each of the first valve and the second valve based on a temperature of the electric motor and a temperature of the brake disc.

2. The cooling system according to claim 1,
wherein the control apparatus is configured to obtain the temperature of the electric motor and the temperature of the brake disc, and to make determinations as to whether each of the electric motor and the brake disc is in a high temperature state that requires cooling, a low temperature state that requires warming-up or an optimum temperature state that is between the high temperature state and the low temperature state, and
wherein the control apparatus is configured to control the opening/closing operations of each of the first valve and the second valve based on results of the determinations as to whether each of the electric motor and the brake disc is in the high temperature state, the low temperature state or the optimum temperature state.

3. The cooling system according to claim 2,
wherein the control apparatus is configured to place the first valve in the closed state and to place the second valve in the open state, when determining that each of the electric motor and the brake disc is in the high temperature state, and
wherein the control apparatus is configured to place each of the first and second valves in the closed state, when determining that each of the electric motor and the brake disc is in the low temperature state.

4. The cooling system according to claim 2,
wherein the control apparatus is configured to place each of the first and second valves in the open state, when determining that the electric motor is in the high temperature state and that the brake disc is in the optimum temperature state, and
wherein the control apparatus is configured to place the first valve in the open state and to place the second valve in the closed state, when determining that the electric motor is in the high temperature state and that the brake disc is in the low temperature state, and when determining that the electric motor is in the optimum temperature state and that the brake disc is in the high temperature state.

5. The cooling system according to claim 1, further comprising, in addition to the cooling passage as a first cooling passage, a second cooling passage that is defined in the wheel so as to cool the liquid medium by heat exchange between the liquid medium and the outside air,
wherein the cooling device is constituted by the wheel that defines therein the second cooling passage.
